(19) United States
(12) Patent Application Publication
(10) Pub. No.: US 2023/0247045 A1
(43) Pub. Date: Aug. 3, 2023

(54) METHOD FOR QUANTITATIVE CYBER RISK MEASUREMENT

(71) Applicant: Morgan State University, Baltimore, MD (US)

(72) Inventors: Wondimu K. Zegeye, Baltimore, MD (US); Richard A. Dean, Marriottsville, MD (US); Farzad Moazzami, Pikesville, MD (US)

(21) Appl. No.: 18/161,848

(22) Filed: Jan. 30, 2023

Related U.S. Application Data
(60) Provisional application No. 63/304,256, filed on Jan. 28, 2022.

(51) Int. Cl. H04L 9/40

(52) U.S. Cl. CPC H04L 63/1433; H04L 63/1416

(57) ABSTRACT

The present invention provides a quantitative method to assess cyber risk. A quantitative risk assessment model simulates attacks with a Poisson random arrival process. The Viterbi algorithm and Baum Welch Algorithm, the underlying foundations of the Hidden Markov Model (HMM), are used to provide a Network Risk Assessment model that infer an attack's intention. Combined, the two methods are effective in assessing cyber risk in real-time.

### BACKGROUND OF THE INVENTION

### Field of the Invention

The present invention relates to cyber threats and methods for assessing their risk.

### SUMMARY OF THE INVENTION

Risk assessments are used to identify, estimate, and prioritize risk organizational operations, organizational assets, personnel, other organizations, and the nation as a whole that depend on the operation and use of information systems. The basis of risk assessments is to notify executive functions and risk responders by pointing to threats, vulnerabilities (inside and outside), and impacts that might be posed by these threats and vulnerabilities. Furthermore, it can compute the likelihood of that impact might occur. However, risk assessment metrics are either assigned as qualitative (low, medium, high severity levels that are assigned for the likelihood) or semi-quantitative (probability values). The present invention provides a quantitative method to assess cyber risk. The Quantitative Risk assessment uses a classical Bayesian estimate. An apriori estimate is based on a Poisson Random arrival probability, and an Exponential Probability Distributions for Detection, Control, and Exploitation, all based on prior history. An aposteriori estimate provides an assessment of risk based on current events in the network and uses the Viterbi algorithm and Baum Welch Algorithm, the underlying foundations of the Hidden Markov Model (HMM), to provide a Network Risk Assessment model that infer an attack's probability. The apriori and aposteriori are then combined to provide an effective quantitative measure of cyber risk in real-time.

Accordingly, there is provided according to the invention a method for quantitatively assessing risk of a computer network to loss from cyber-attack, comprising the steps of: developing apriori estimates of risk based on historical network data; developing aposteriori estimates of risk based on current network data; combining apriori estimates and aposteriori estimates of risk into a real time estimate for the network; wherein said developing apriori estimates and developing aposteriori estimates and combining apriori estimates and aposteriori estimates are executed on one or more computer processors according to computer readable instructions stored on non-transient computer storage media.

There is further provided according to the invention a method for quantitatively assessing risk of a computer network to loss from cyber-attack, comprising the steps of: developing an apriori probability model to attack arrival, success, control, and exploitation using Bayesian methods and historical data; monitoring network packet data on said computer network; generating a current (aposteriori) network risk assessment using a Hidden Markov Model based on said network packet data; populating and updating apriori and aposteriori risk probability matrices with

A, the probability of attack present in time T_{A}

W, the probability of attack success in time T_{W}

C̅, the probability of attack not being controlled in time.

E, the probability exploitation in time T_{E}.

based on data from said Hidden Markov Model; and estimating a risk of loss from said apriori and aposteriori risk probability matrices using the formula: Estimated Risk=Σᵢpₛ(i)Loss(τ)ᵢ, wherein said developing, monitoring, generating, populating and updating, and estimating steps are executed on one or more computer processors according to computer readable instructions stored on non-transient computer storage media.

### BRIEF DESCRIPTION OF THE DRAWINGS

The foregoing summary, as well as the following detailed description of the preferred invention, will be better understood when read in conjunction with the appended drawings. For the purpose of illustrating the invention, they are shown in the drawings embodiments which are presently preferred. It should be understood, however, that the invention is not limited to the precise arrangements and instrumentalities shown. In the drawings:

FIG. 1 is a representation of the quantitative risk model according to an embodiment of the invention.

FIG. 2 is a representation of how the aposteriori and apriori risk probabilities are used to determine the estimated risk of an organization.

FIG. 3 is a representation of the Monte Carlo Risk Model using information from the Hidden Markov Model, according to an embodiment of the invention.

FIG. 4 is a representation of attack-detection event probability thresholds in a Monte Carlo Risk simulation using data from the Hidden Markov Model, according to an embodiment of the invention.

FIG. 5 is a representation of successful penetration events and cost in a Monte Carlo Risk simulation using data from the Hidden Markov Model, according to an embodiment of the invention.

### DETAILED DESCRIPTION OF THE INVENTION

Poisson Random Arrival Process.

The quantitative risk model of the invention is shown in FIG. 1 and provides the context for an estimate of risk using Poisson probability density function (“pdf”). The model consists of two layers of an information system infrastructure (weakness and control) that an attack must bypass to have a technical impact on the resources of the system and harm the business of an organization. This work involves several layers to assess Risk: the Attack Model, the Vulnerability Model, the Control Model, and the Impact Model.

Attack Model. In a network, cyber-attacks are considered random processes with a Poisson probability density function (“pdf”). For a specified time-interval (τ), the probability of k occurrences of attack i is given by:

$${p}_{i} ( k ) = \frac{{λ}_{i}^{k} {e}^{{λ}_{i}}}{k !}$$

where λᵢ is the average arrival rate of k occurrences of attack i over τ.

Vulnerability Model. The success of an attack depends on the vulnerability in the system and its ability to avoid detection. An exponential probability distribution function is a good representative of detection over a period τ.

p_{d}=λ₂e^{λ}^{₂}^{τ}

where λ₂ represents the average time for detection, and τ is the time it takes (attack or detection).

Control Model. This models how much time it takes to put network security control in place after detection of a successful attack. The probability of penetration detection is used to model the network security control and exponential probability distribution function and is a good representative.

p_{d}=λ₃e^{λ}^{₃}^{τ}

where λ₃ represents the average time to control attack.

Impact Model. Successful penetrations cause damage to the organization's data and loss of service. Here the impact of the penetration is a tangible loss limited by the net worth ($NW) of the enterprise. The magnitude of the loss due to attack i is assumed to be proportional to the total penetration time (τₚ) which exponentially approaches the net worth.

Lossᵢ(τ)=(1−e^{-λ}^{₄}^{τ}^{ₚ})$NW

where λ₄ represents the time constant for dissipation of assets from the enterprise network.

Risk. Based on the foregoing layers, the risk to a network of cyber-attacks is computed as an accumulation of costs and their associated probabilities.

Risk=Σᵢpₛ(i)Loss(τ)ᵢ

where pₛ is the probability of success of an attack pₛ=1−p_{d}.

Hidden Markov Model.

Turning to the HMM aspect of the invention, the HMM consists of a set of N distinct “hidden” states of the Markov process Q={q₁, q₂, . . . , q_{N},} and a set of M observable symbols per State={v₁, v₂, . . . , v_{M},}. The overall HMM model is defined as follows with qₜ and oₜ denoting the state and observation symbol at time t, respectively.

The HMM is specified by a set of parameters (A, B, Π):
i. The prior probability distribution Π=Πᵢ where Πᵢ=P(q₁=sᵢ) are the probabilities of sᵢ being the state sᵢ at the beginning of the state sequence.
ii. The transition probability matrix A={aᵢⱼ} where aᵢⱼ=P(qₜ₊₁=sⱼ|qₜ=sᵢ), are the probabilities of going from state sᵢ to state sⱼ.
iii. The emission (observation) probability matrix B={bᵢₖ} where bᵢₖ=P(oₜ=vₖⱼ|qₜ=sᵢ) are the probabilities to observe sₖ if the current state is qₜ=sᵢ.

A new feature vector is constructed from the Layer 1 HMMs probable sequence of states. This statistical feature can be considered as a new data matrix VQ that can be applied and a new sequence of observations will be created from the Layer 2 HMM.

The feature vector is constructed as follows:

$${f}_{i} = ( \begin{matrix}\begin{matrix}{q}_{1}^{i} \\ ⋮\end{matrix} \\ {q}_{T}^{i}\end{matrix} ) , ∀ i = 1 , 2 , … , p$$

$$F = ( {f}_{1} , {f}_{2} , … {f}_{j} ) , ∀ j = 1 , 2 , … , p$$

The Viterbi algorithm finds the best probable path (P) via the model that has the maximal probability given an observed sequence. In other words, the estimated states sequence presents a “most likely” explanation for the observation sequence, given the HMM model parameters. The states in the HMM represent the presence of attacks in the network based on current network traffic, and associated probabilities. This represents useful estimates of the immediate status of the network but does not have the context to estimate the actual risk of the network.

Poisson and HMM, Combined.

The combination of the above-described methodologies considers four stages of an attack: Attack (A), Weakness (W), Control (C) and Exploit (E). The following random variables are assigned:

A is probability of attack present in time T_{A}

W is the probability of attack success in time T_{W}

C̅ is the probability of attack not being controlled in time.

E is the probability exploitation in time T_{E}.

Bayes theorem (also “Bayes rule”) is applied to the joint pdf P(A, W, C̅, E) as follows:

P(E)=P(E|AWC̅)P(AWC̅)

P(AWC̅)=P(C̅|AW)P(AW)

P(AW)=P(W|A)P(A)

Combining the above equations provides an overall probability of exploitation as:

P(E)=P(E|AWC̅)P(C̅|AW)P(W|A)P(A)

An expression for each one of these probabilities for each of N possible attacks P(Aₖ), the probability of one or more attacks present. Assuming a Poisson pdf of the attacks, the probability of k events in time τ₁ with λ₁ being the average events in τ₁ is chosen as a constant one or more events is equal to 1−P(k=0)

P(Aₙ)=1−e^{-λ}^{₁}^{τ}^{₁}

P(Wₙ|Aₙ) is the probability that a weakness Wₙ will be compromised given the presence of Aₙ in an interval T₂. Assume this random variable has an exponential pdf:

P_{τ}_{₂}(Wₙ|Aₙ)=∫₀^{τ}^{₂}λ₂e^{-λ}^{₂}^{t}dt

where τ₂ is a convenient interval, for example, 1 day. P_{τ}_{₂} (Wₙ|Aₙ) is the probability of a successful attack.

P_{τ}_{₂}(Wₙ|A)=∫₀^{τ}^{₂}λ₂e^{-λ}^{₂}^{t}^{₂}dt=e^{-λ}^{₂}^{t}]₀^{τ}^{₂}=1−e^{-λ}^{₂}^{τ}^{₂}

Pₙ (C̅|AₙWₙ) is the probability that an attack is not controlled given a successful attack Aₙ and weakness Wₙ. Assume that the time to control an attack has an exponential pdf, then

P_{τ}_{₃}(C̅|AW)=1−∫₀^{τ}^{₃}λ₃e^{-λ}^{₃}^{t}dt=e^{-λ}^{₃}^{τ}^{₃}

Finally,

P_{n,τ}_{₄}(E)=P(E|AₙWₙC̅ₙ)=∫₀^{τ}^{₄}λ₄e^{-λ}^{₄}^{t}dt=1−e^{-λ}^{₄}^{τ}^{₄}

Combining a set of equations:

P_{n,τ}_{₄}(E)=(1−e^{-λ}^{₄}^{τ}^{₄})(e^{-λ}^{₃}^{τ}^{₃})(1−e^{-λ}^{₂}^{τ}^{₂})(1−e^{-λ}^{₁}^{τ}^{₁})

Next, a Risk Probability matrix based on probabilities 0 with attacks n=1, 2, . . . , N possible known attacks of interest shown below.

$$\begin{matrix}\begin{matrix}\begin{matrix}\begin{matrix}P ( A ) & P ( w )\end{matrix} & P ( \overline{C} )\end{matrix} & P ( E )\end{matrix} \\ \begin{matrix} & & & & \\ {A}_{1} & P ( {A}_{1} ) & P ( {W}_{1} ) & P ( {\overline{C}}_{1} ) & P ( {E}_{1} ) \\ {A}_{2} & P ( {A}_{2} ) & P ( {W}_{2} ) & P ( {\overline{C}}_{2} ) & P ( {E}_{2} ) \\ ⋮ & ⋮ & ⋮ & ⋮ & ⋮ \\ {A}_{N} & P ( {A}_{N} ) & P ( {W}_{N} ) & P ( {\overline{C}}_{N} ) & P ( {E}_{N} )\end{matrix}\end{matrix}$$

Apriori Risk. In the absence of specific events, this represents an apriori state of the network where the λ's and T's in previous equations are set to some ambient condition from which a risk measure might be computed. This risk measure might follow from prior data, evaluations, practices, and certifications the network may have been awarded.

Aposteriori Risk. Now imagine that events dictate a change in the risk of the network. Say that some new vulnerability, N+1, is discovered. Perhaps a zero-day vulnerability. This particular vulnerability will have its own set of λ's and T's which reflect the increased vulnerabilities of the network. Weaknesses are present at 100% for some time interval and detection and control are absent. This new vulnerability might then significantly increase the risk of the network for some interval of time. This risk measure is the aposteriori risk given the presence of the new event.

The addition of an Intrusion Detection System (IDS) with an HMM engine can detect an attack and provides a confidence level (probability). Depending on the attack and the location of the IDS in the network, the P(E) for each attack is modified by modification of the Risk/Attack matrix. The next step is to map the assortment of attacks and locations in the network into a revised Risk/Attack matrix.

Consider, for example, the detection of a reverse (outbound) channel (Aₖ) to a non-approved IP address. Aₖ is one of the known N attacks. This would change the risk matrix by replacing the apriori risk values with updated values as

Pₖ(A)=Hₖ,Pₖ(W)=Hₖ,Pₖ(C̅)=Hₖ

This specific event would say that the attack was both present and successful, but not yet controlled. If the IDS was internal the router firewall could block this with some probability. Where Hₙ corresponds to the confidence level of the HMI detection and forces P(Wₖ)=Hn. An attack detected matrix is shown below.

$$\begin{matrix}\begin{matrix}\begin{matrix}\begin{matrix}P ( A ) & P ( w )\end{matrix} & P ( \overline{C} )\end{matrix} & P ( E )\end{matrix} \\ \begin{matrix} & & & & \\ {A}_{1} & P ( {A}_{1} ) & P ( {W}_{1} ) & P ( {\overline{C}}_{1} ) & P ( {E}_{1} ) \\ {A}_{2} & P ( {A}_{2} ) & P ( {W}_{2} ) & P ( {\overline{C}}_{2} ) & P ( {E}_{2} ) \\ ⋮ & ⋮ & ⋮ & ⋮ & ⋮ \\ {A}_{k} & P ( {A}_{k} ) & P ( {W}_{k} ) & P ( {\overline{C}}_{k} ) & P ( {E}_{k} ) \\ ⋮ & ⋮ & ⋮ & ⋮ & ⋮ \\ {A}_{n} & P ( {A}_{n} ) & P ( {W}_{n} ) & P ( {\overline{C}}_{n} ) & P ( {E}_{n} )\end{matrix}\end{matrix}$$

At this point, the residual risk will shoot up where only the exploit time constant affects the risk.

Combining Multiple Attacks. In the case of (N) multiple attack elements and associated P(Eₙ), n=1, 2, . . . , N, the overall risk depends on all of the attacks being managed. The probability of all N attacks being managed is the probability P(E₁)∩P(E₂)∩ . . . ∩P(Eₙ). The probability they are managed for any Eₙ is 1−P(Eₙ). Thus, the joint probability they are all managed is given by

$${\prod }_{n = 1}^{n = N} ( 1 - P ( {E}_{n} ) )$$

And the probability they are not managed is

$$P ( E ) = 1 - {\prod }_{n = 1}^{n = N} ( 1 - P ( {E}_{n} ) )$$

where this is the probability that N attacks lead to a successful exploit. Note that any one P(Eₙ) approaching 1 then sets P(E) going to 1. Likewise, note that as the number of attacks grows large, the P(E) tends toward 1.

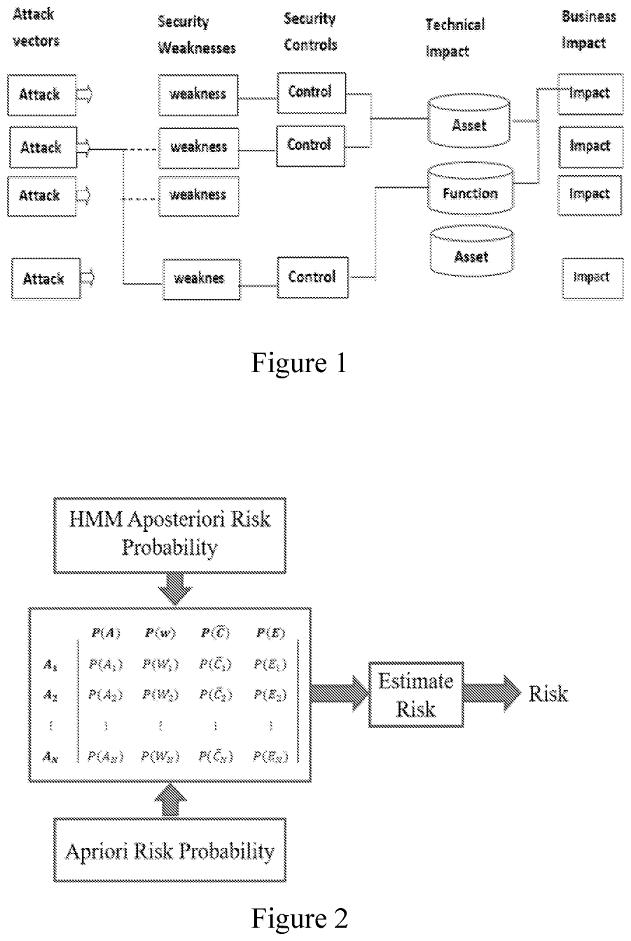

Risk Estimate. The risk estimate follows from the apriori and aposteriori risk probability matrices and the risk calculation above, Risk=Σᵢ pₛ(i)Loss(τ)ᵢ, as shown in FIG. 2. These estimates will vary over time as the apriori (historical) measure of risk and aposteriori (sensed) measure of risk are updated. Each of these are updated based on historical data from this system, from outside risk update (zero-day attacks) or from local risk updates from the Intrusion Detection System.

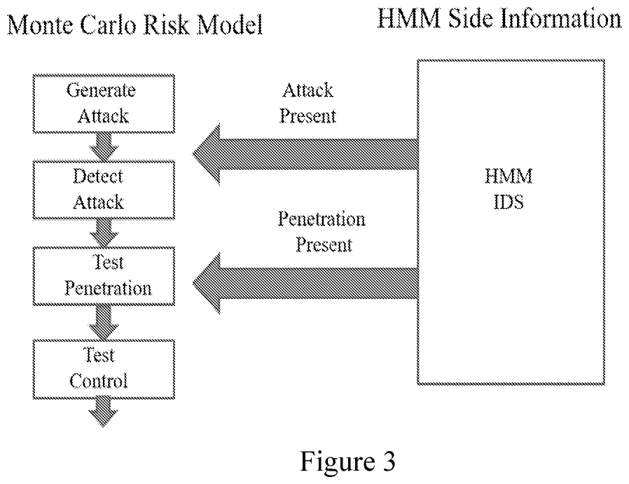

Risk Measurement Monte-Carlo Simulation. The risk model that uses HIVIM-side information is based on the MATLAB code used for the risk model. FIG. 3 provides the overview of the system. On the left is a risk model, it has been reconfigured, but by and large, it is the same model. The progression of a cyber-attack starts off with randomly generating an attack of one and possible attacks.

HMM-Side Information-Monte Carlo Simulation. Using Monte Carlo simulation, attacks will have a Poisson probability distribution. These attacks then are filtered through a detection process. An exponential probability distribution characterizes the probability of detecting that attack. At the detection layer, some of these attacks will be detected, in which case they do not proceed. There is also an expectation that there is an exponential probability distribution, that over time, an attack that is present will penetrate. Thus, this third stage models the penetration of an attack.

The last stage is to see if there could be a control of that attack. Again, an exponential probability distribution characterizes the behavior of a control function, so the longer the time, the more likely it will be controlled. The output of this is some aggregate measure of risk, which we do not show here.

On the right side of FIG. 3, the HMM-side information is presented and modeled, again as a Monte Carlo simulation. It does not actually implement the HMM but characterizes the output, which we have seen in similar HMM IDSs. When the HMM event occurs, it creates side information, that is, that an attack is present. In this model, good background attack information is generated, what is deemed for purposes of the invention, a priori information. And now we have aposteriori information, which says we have just detected an attack. The information is integrated into the attack structure. For example, there is a much higher probability of attack because side information warns that an attack is actually present.

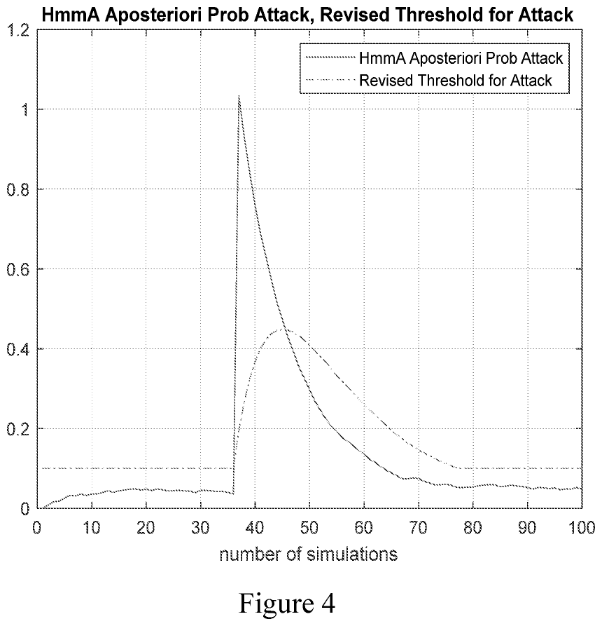

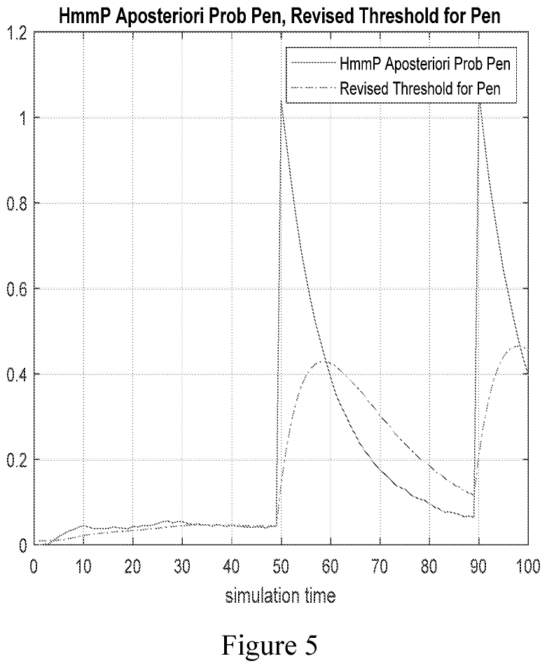

This is done in two places, one is to present to actually indicate the presence of an attack (FIG. 4), and the second is the presence of a penetration event (FIG. 5). Normally, the Hidden Markov Model in intrusion detection systems operates in two different planes. One is at the front end of the system, where it is looking for the presence of attacks in the system, and then there is intrusion detection on the back end, in short, the types of attacks that would indicate that a penetration has occurred. These two types of attacks basically drive this model. And for both ends, we take the Monte Carlo with exponential probability at the penetration layer, which is a flat probability, and then add into that the mixture of a new event which occurs when an intrusion detection event takes place.

When an event occurs, the event is smoothened out, so it is distributed over time. The revised threshold is the blending of the HMM with the background level. The result is an exponential function that provides an exaggerated threshold over time showing the probability function, see FIG. 4.

The Hidden Markov Model penetration probabilities generated for the penetration events are depicted in FIG. 5 as the Posteriori probability of attack. In this scenario, two events occurred. The memory filter faded somewhat, and this basically changed the threshold. The HmmP function was filtered in and demonstrated a penetration value that was accelerated over the period of the events. It also starts to fade away back to some threshold value.

It will be appreciated by those skilled in the art that changes could be made to the preferred embodiments described above without departing from the inventive concept thereof. It is understood, therefore, that this invention is not limited to the particular embodiments disclosed, but it is intended to cover modifications within the spirit and scope of the present invention as outlined in the present disclosure and defined according to the broadest reasonable reading of the claims that follow, read in light of the present specification.

1. A method for quantitatively assessing risk of a computer network to loss from cyber-attack, comprising the steps of:
developing apriori estimates of risk based on historical network data;
developing aposteriori estimates of risk based on current network data;
combining apriori estimates and aposteriori estimates of risk into a real time estimate for the network;
wherein said developing apriori estimates and developing aposteriori estimates and combining apriori estimates and aposteriori estimates are executed on one or more computer processors according to computer readable instructions stored on non-transient computer storage media.

2. A method for quantitatively assessing risk of a computer network to loss from cyber-attack, comprising the steps of:
developing an apriori probability model to attack arrival, success, control, and exploitation using Bayesian methods and historical data;
monitoring network packet data on said computer network;
generating a current (aposteriori) network risk assessment using a Hidden Markov Model based on said network packet data;
populating and updating apriori and aposteriori risk probability matrices with
A, the probability of attack present in time T_{A}
W, the probability of attack success in time T_{W}
C̅, the probability of attack not being controlled in time.
E, the probability exploitation in time T_{E}.
based on data from said Hidden Markov Model;
and estimating a risk of loss from said apriori and aposteriori risk probability matrices using the formula: Estimated Risk=Σᵢpₛ(i)Loss(τ)ᵢ,
wherein said developing, monitoring, generating, populating and updating, and estimating steps are executed on one or more computer processors according to computer readable instructions stored on non-transient computer storage media.
